(19) United States
(12) Patent Application Publication
(10) Pub. No.: US 2026/0228931 A1
(43) Pub. Date: Aug. 6, 2026

(54) SYSTEMS AND METHODS FOR IMAGE MERGING BASED ON OVERLAP RATIO

(71) Applicant: Verizon Patent and Licensing Inc., Basking Ridge, NJ (US)

(72) Inventors: Suresh Koneri Chandrasekaran, Chennai (IN); Sudipta Patowary, Bengaluru (IN)

(21) Appl. No.: 19/045,654

(22) Filed: Feb. 5, 2025

(51) Int. Cl. G06T 11/00; G06T 3/16

(52) U.S. Cl. CPC G06T 11/00; G06T 3/16; G06T 2210/12; G06T 2210/21

(57) ABSTRACT

Systems and methods provide efficient and accurate merging of images. A computing device receives multiple images including a first image and a second image. The computing device detects objects in pixel array representations of each of the multiple images and generates a bounding box for each of the objects. The computing device computes an overlap ratio for a first bounding box in the first image and a second bounding box in the second image and identifies the first and second bounding box as an overlapping region when the overlap ratio exceeds a defined merge threshold. The computing device appends pixels within the overlapping region to form a merged area and creates a merged pixel array representation of the first image and the second image from a pixel array of the first image, a pixel array of the second image, and a pixel array representation of the merged area.

### BACKGROUND

Images may be used for object recognition in a variety of applications. When a single image is insufficient to capture an observed area, image data obtained from multiple images may be combined to produce a single image, such as a panoramic view image. Common image merging algorithms do not always provide the best results when trying to merge multiple images.

### BRIEF DESCRIPTION OF THE DRAWINGS

FIG. 1 is a diagram illustrating concepts described herein;

FIG. 2 is a diagram that depicts an exemplary network environment in which systems and methods described herein may be implemented;

FIG. 3 depicts example components of a network device, according to an implementation;

FIG. 4 is a diagram of examples of logical components that may be included in An image processing system, according to an implementation;

FIG. 5 is a diagram of a process for determining an overlap ratio for bounding boxes, according to an implementation;

FIG. 6 is diagram of a process for merging images based on overlap ratio, according to an implementation described herein; and

FIGS. 7 and 8 are process flow diagrams for image merging based on overlap ratio, according to another implementation.

### DETAILED DESCRIPTION

The following detailed description refers to the accompanying drawings. The same reference numbers in different drawings may identify the same or similar elements. Also, the following detailed description does not limit the invention.

Systems and methods described herein provide an efficient and accurate image merging system. Common image merging processes do not always provide optimal results when trying to merge multiple (e.g., three or more) images. Conventional merging techniques tend to cause a final image to fray towards the end of the last merged image. The final image may also lose some of its contrast and become hazy. Further, inefficiency in merging two images will be carried forward to a third image, and so on. As the number of images increases, the propagation of error/noise in merging subsequent images will keep increasing. Thus, existing processes are not highly reliable when merging multiple images together, especially when the end objective is to detect and identify objects in the final image.

According to implementations described herein, an image processing unit first identifies objects in the individual images, and then based on the objects identified, estimates the amount of overlap between two images. Subsequently, array representations of the two images are appended to generate an array representation of the merged image. The systems and methods described herein provide a more efficient technique to detect objects in the merged image, rather than merging the images together first (i.e., using conventional techniques) and then trying to identify objects.

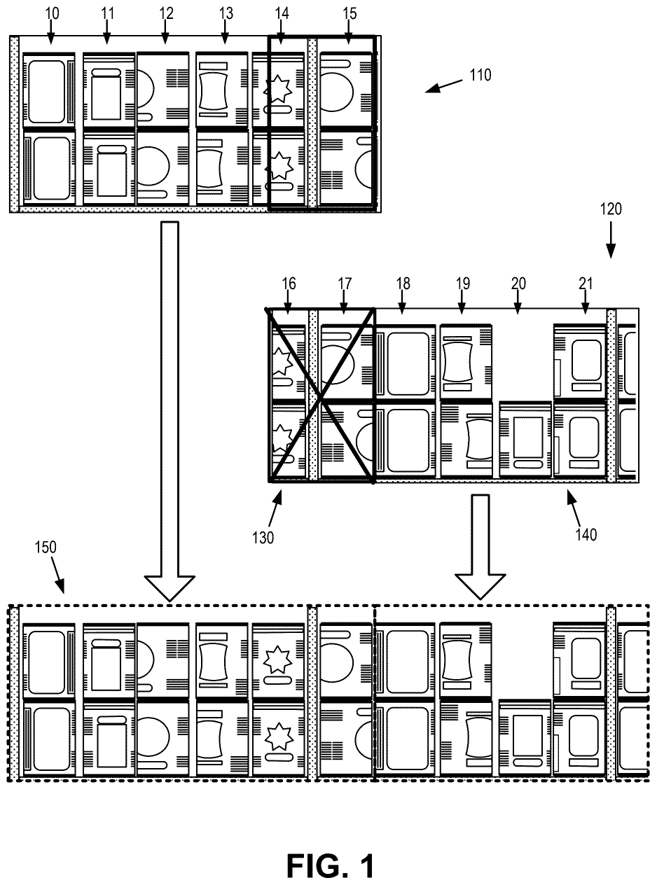

FIG. 1 is a diagram illustrating concepts described herein. In a use case, object recognition may be useful for inventory management, such as tracking products on a store shelf. Retail stores and warehouses may store a significant number of products, and capturing images of the shelves may be helpful for understanding and optimizing product quantity and placement. Typically, multiple pictures are needed to capture an entire shelf area with sufficient resolution to enable object recognition.

FIG. 1 includes a first image 110 of products (e.g., stacked cans on shelving) and a second image 120 of products. Assume the second image 120 overlaps with the first image 110. Each of first image 110 and second image 120 may be represented in an imaging system as an array of pixels (e.g., a 1024-by-1024 pixel array) with each pixel having a defined location and a red, green, and blue (RGB) pixel value (e.g., a numerical value ranging from zero to 255).

Given image 110 and image 120, the image processing system may perform object detection to identify objects 10-15 in image 110 and objects 16-21 in image 120. Each of objects 10-21 may be identified, for example, with bounding boxes (not shown for clarity). The image processing system may compare, for example, the far right objects 15 in image 110 with the far left objects 16 in image 120 for a possible merging area. Finding that objects 15 do not match objects 16, the image processing system may move on to compare the far right objects 15 in image 110 with the next objects 17 in image 120. Upon determining that objects 17 match objects 15, the image processing system may work back and compare objects 14 in image 110 with objects 16 in image 120. Finding that objects 14 and objects 16 match, and that objects 16 are located at the end (edge) of image 120, the image processing system may correctly identify the area 130 (e.g., including objects 16 and 17) where image 120 overlaps image 110. The overlapping area 130 of image 120 may be defined, appended, and/or removed. For example, the overlapping area 130 may be discarded from image 120. The remaining portion 140 of image 120 may be joined to image 110 to form merged image 150.

As described further herein, the image processing system may use an overlap ratio to detect overlapping objects, providing the coordinates of the bounding box encapsulating the individual objects as well as the dimensions (height and width) of the objects. The images may be merged by using their pixel array representations and the overlap ratio for the bounding boxes. The arrays of the images may be reviewed, and an object detection process may be used to identify the objects that are common/overlapping in the two images. Based on the overlap, the arrays may be appended together to obtain the pixel array representation of the merged images. The pixel array representation from the appended arrays can then be used to generate the final merged image.

In the simplified illustration of FIG. 1, overlap ratios for bounding boxes are calculated along a single shared edge for two images. In other implementations, overlap ratios may be calculated for multiple images along multiple edges in different directions. While the illustration of FIG. 1 provides an embodiment that relates to inventory tracking, the image merging system described herein may be applicable in other use cases that relate to, for example, object tracking. In another implementation, the image merging system may be used to inspect for missing and/or physically damaged equipment on structures, such as equipment on telecom towers, dams, water towers, etc. Images of the structures may be captured, and the images of objects present on the structures may be compared to the objects present in an image catalog of a fully functioning structure to check for any missing equipment and/or physical anomalies that could potentially lead to operational issues.

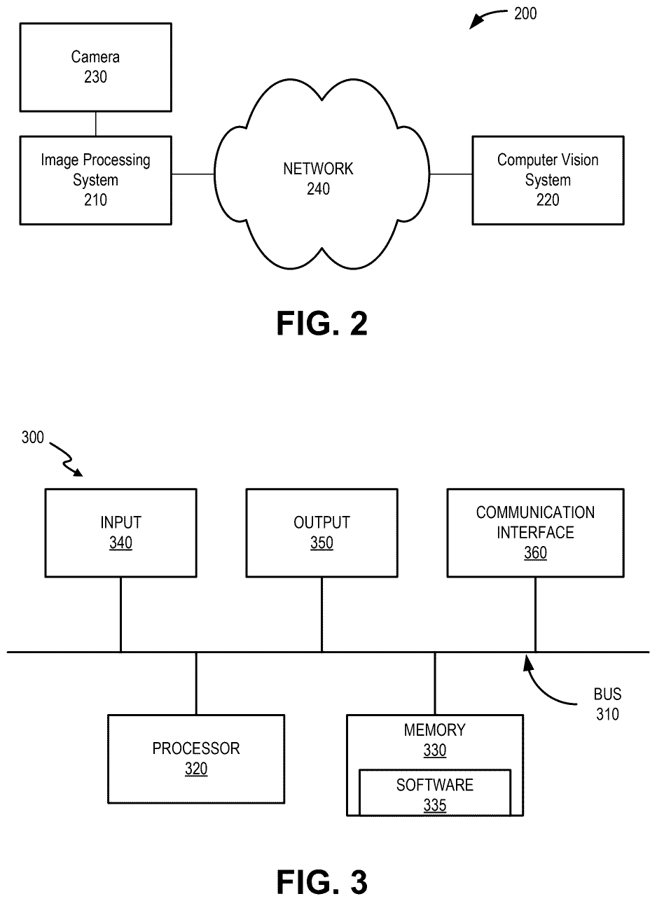

FIG. 2 is an example of a network environment 200 in which the image merging system described herein may be implemented. As illustrated, network environment 200 may include an image processing system 210 and a computer vision system 220 interconnected by a network 240. Components of network environment 200 may be connected via wired and/or wireless links. According to an implementation, image processing system 210 may be located locally with respect to a camera 230 or located remotely with respect to camera 230.

Image processing system 210 may include a processor, a computing device, or a network device to process images or an image stream from one or more content sources (e.g., camera 230) as described further herein. Each image may include or be defined by a pixel array, such as an RGB array, which is a data structure used to represent the image in a RGB (red, green, blue) color model. As described in more detail below, image processing system 210 may use the RGB arrays to identify objects within images, generate bounding boxes for each of the objects, identify bounding box locations/dimensions, and/or identify alike/similar objects in different images.

Computer vision system 220 may analyze merged images generated by image processing system 210. For example, computer vision system 220 may use merged images to track inventory or determine whether objects show changes/patterns of interest. According to an implementation, computer vision system 220 may perform object tracking for a designated area, such as retail store shelves, warehouse shelves, towers, infrastructure, etc.

Camera 230 may obtain images that may be used/merged in the image merging system. Camera 230 may include, for example, an array of digital image sensors, such as charged-couple device (CCD) sensors, complementary metal-oxide-semiconductor (CMOS) sensors, and/or other types of digital image sensors configured to capture color images. For example, camera 230 may obtain red, green, and blue (RGB) values for each pixel in a captured image to form an RGB array. In some implementations, camera 230 may be integral with another device, such as smart phone, a drone, a security system, a computer, a wearable device (e.g., an Augmented Reality/Virtual Reality (AR/VR) headset, etc. Camera 230 may be configured to provide images and/or RGB arrays to image processing system 210 either via a direct connection or a network (e.g., network 240). In one implementation, camera 230 may be included in a single mobile device that can move/rotate to collect a series of overlapping images. In another implementation, camera 230 may include multiple fixed devices that are mounted with overlapping fields-of-view to collect a series of overlapping images. In one implementation, camera 230 may provide images to image processing system 210 as a group or burst of images obtained simultaneously or sequentially over a short period of time (e.g., a few seconds or less).

Network 240 may include a local area network (LAN); an intranet; the Internet; a wide area network (WAN), such as a cellular network, a satellite network, a fiber optic network, a private WAN, or a combination of the Internet and a private WAN; etc., that is used to transport data. Although shown as a single element in FIG. 2, network 240 may include a number of separate networks that function to provide services for the image merging system. Thus, the image merging system may be implemented locally (e.g., at customer premises), remotely (e.g., as a cloud-or edge-based network service), or in a distributed environment.

In FIG. 2, the particular arrangement and number of components of network environment 200 are illustrated for simplicity. In practice, network environment 200 may include more image processing systems 210, computer vision systems 220, cameras 230, or networks 240.

FIG. 3 is a diagram illustrating exemplary components of a device 300. Video processing system 210, computer vision systems 220, or another device in network environment 200 may each include one or more devices 300 or may be implemented on one of more devices 300. As shown in FIG. 3, device 300 may include a bus 310, a processor 320, a memory 330 including software 335, an input device 340, an output device 350, and a communication interface 360.

Bus 310 may include a path that permits communication among the components of device 300. Processor 320 may include any type of single-core processor, multi-core processor, microprocessor, latch-based processor, and/or processing logic (or families of processors, microprocessors, and/or processing logic) that interprets and executes instructions. In other embodiments, processor 320 may include an application-specific integrated circuit (ASIC), a field-programmable gate array (FPGA), and/or another type of integrated circuit or processing logic.

Memory 330 may include any type of dynamic storage device that may store information and/or instructions, for execution by processor 320, and/or any type of non-volatile storage device that may store information (e.g., software 335, data, etc.) for use by processor 320. For example, memory 330 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Software 335 includes an application or a program that provides a function and/or a process. Software 335 may also include firmware, middleware, microcode, hardware description language (HDL), and/or other form of instruction. By way of example, with respect to computing elements that include logic to identify overlap ratios and/or merge images, these elements may be implemented via software 335.

Input device 340 may allow an operator to input information into device 300. Input device 340 may include, for example, a keyboard, a mouse, a pen, a microphone, a remote control, an audio capture device, an image and/or video capture device such as camera 230, a touch-screen display, and/or another type of input device. In some embodiments, device 300 may be managed remotely and may not include input device 340.

Output device 350 may output information to an operator of device 300. Output device 350 may include a display, a printer, a speaker, and/or another type of output device. For example, device 300 may include a display, which may include a liquid-crystal display (LCD) for displaying content to the customer. In some embodiments, device 300 may be managed remotely and may not include output device 350.

Communication interface 360 may include a transceiver that enables device 300 to communicate with other devices and/or systems via wireless communications (e.g., radio frequency (RF), infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to RF signals and/or a receiver that converts RF signals to baseband signals. Communication interface 360 may be coupled to one or more antennas/antenna arrays for transmitting and receiving RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., a Wi-Fi™) card for wireless communications. Communication interface 360 may also include a universal serial bus (USB) port for communications over a cable, a Bluetooth™ wireless interface, a radio-frequency identification (RFID) interface, a near-field communications (NFC) wireless interface, and/or any other type of interface that converts data from one form to another form.

As will be described in detail below, device 300 may perform certain operations related to image merging. Device 300 may perform these operations in response to processor 320 executing instructions (e.g., software 335) contained in a computer-readable medium, such as memory 330. A computer-readable medium may be defined as a non-transitory memory device. A memory device may be implemented within a single physical memory device or spread across multiple physical memory devices. The software instructions may be read into memory 330 from another computer-readable medium or from another device. The software instructions contained in memory 330 may cause processor 320 to perform processes described herein. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently arranged components than depicted in FIG. 3. Additionally, or alternatively, one or more components of device 300 may perform one or more tasks described as being performed by one or more other components of device 300.

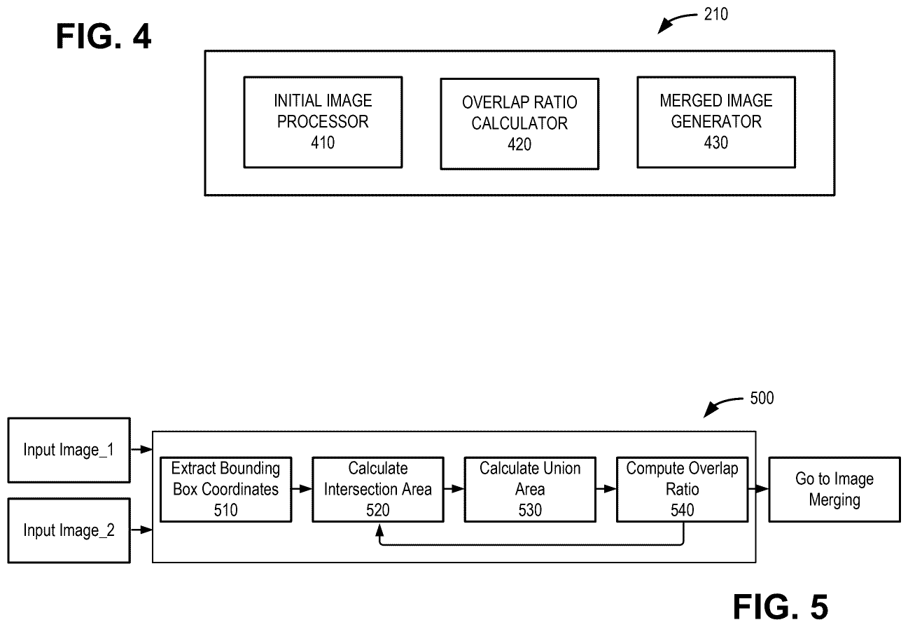

FIG. 4 is a block diagram illustrating examples of logical components of image processing system 210. The components of image processing system 210 may be implemented, for example, via processor 320 executing software 335 from memory 330. Alternatively, some or all of the components of image processing system 210 may be implemented via hard-wired circuitry. As shown in FIG. 4, image processing system 210 may include an initial image processor 410, an overlap ratio calculator 420, and a merged image generator 430.

Initial image processor 410 may be configured to receive images or an image stream from a camera (e.g., camera 230). According to an implementation, initial image processor 410 may receive images and cache/buffer the images. In one implementation, initial image processor 410 may convert and/or analyze an RGB array of each image. In other implementations, initial image processor 410 may convert and/or analyze an sRGB (which includes transparency) or CMYK (Cyan, Magenta, Yellow, and Key) array. Using the RGB array, for example, initial image processor 410 may perform initial object detection and other processing of each received image. For example, initial image processor 410 may detect one or more objects of interest (e.g., products, equipment, etc.) in an image.

According to an implementation, initial image processor 410 may store an object detector model trained to identify different types of objects. The object detector model may identify objects of interest in each image (e.g., of a set of images received from camera 230). For example, depending on a purpose or use case, the object detector model may be directed toward identifying, specific types of items, structures, inventory, people, vehicles, or other mobile objects. In one implementation, initial image processor 410 may annotate each image in a group of images by labeling identified objects (e.g., as a certain type of product, structure, equipment, etc.), assign bounding boxes for each object, and/or assign unique identifiers for each object/bounding box. Initial image processor 410 may also provide coordinates of each bounding box that encapsulates the individual objects, as well as the dimension information (i.e., height and width) of the object/bounding box.

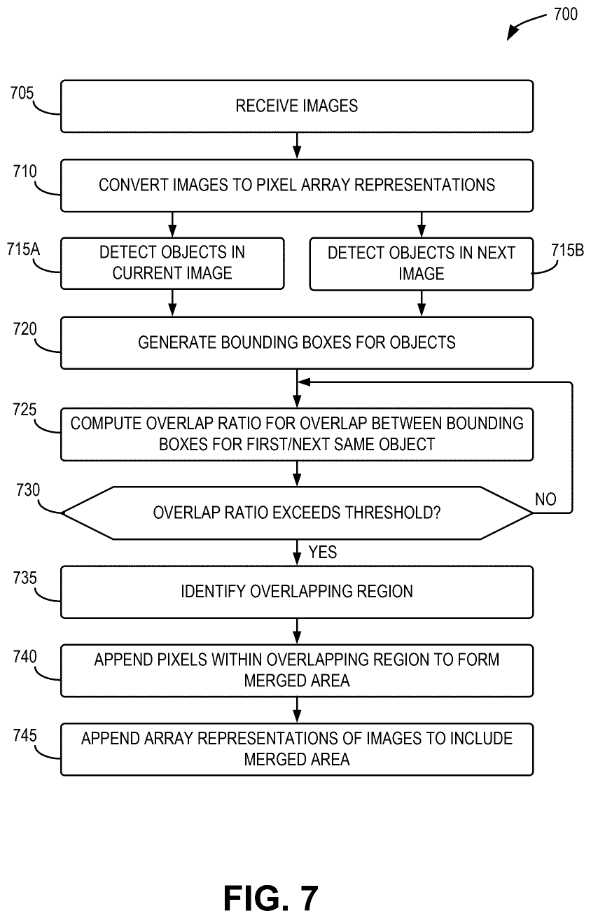

Dimension information may refer to bounding box coordinates, which define the position and size of objects detected in the images. Dimensions of objects may be determined during an object detection step (e.g., step 715A/715B of FIG. 7 described below) prior to merging of different images. The output of the object detection may include bounding box coordinates (e.g., specifying the rectangular area around a detected object), a class label (e.g., identifying the type of object, such as a car, tree, building, etc.), and a confidence score (e.g., indicating the certainly level of the detection). Dimension information may help identify and compare objects between two images. By comparing the bounding box dimensions (e.g., size and location), the initial image processor 410 may determine if objects in two images are similar or different. For example, objects with overlapping bounding boxes and similar sizes may be considered the same, while non-overlapping or significantly different dimensions may indicate different objects. If the images have different resolutions or perspectives, initial image processor 410 may use the dimensions to scale the objects before comparing (e.g., by overlap ratio calculator 420). For example, if an object in one image is twice the size of the same object in the other image, initial image processor 410 may normalize the dimensions to match their scales before overlap ratio calculator 420 calculates the overlap. In one implementation, bounding box coordinates may be represented in a cartesian coordinate system, such as a 1024-by-1024 pixel grid, with each rectangular bound box represented by a minimum x, y (x−min, y−min) coordinate and a maximum x, y (x−max, y−max) coordinate pair. Initial image processor 410 may group and feed processed images to overlap ratio calculator 420.

Overlap ratio calculator 420 may estimate the amount of overlap between two images based on objects identified in the images. Overlap ratio calculator 420 may use the bounding box dimensions for aligning objects between two images when merging: Overlap ratio calculator 420 may compute the overlap between bounding boxes from both images. Objects with sufficient overlap may eventually be merged into the same region in the final image. FIG. 5 is an example of a process 500 for overlap ratio calculator 420 according to an implementation. As shown in FIG. 5, overlap ratio calculator 420 may receive or select two images for comparison, such as image_1 and image_2, which may be received from initial image processor 410. Each image may have multiple objects and bounding boxes.

As shown in step 510, for each of image_1 and image_2, overlap ratio calculator 420 may extract bounding box coordinates from the corresponding pixel array representations (also referred to as RGB array representations) of each image. For example, overlap ratio calculator 420 may extract minimum x, y (x−min1, y−min1) coordinates and maximum (x−max1, y−max1) coordinates for a first bounding box (bbox1) in image_1 and extract minimum x, y (x−min2, y−min2) coordinates and maximum (x−max2, y−max2) coordinates for a second bounding box (bbox2) in image_2. In one implementation, overlap ratio calculator 420 may initially attempt to select bounding boxes of the same object from opposite edges of each image pair. In other implementations, overlap ratio calculator 420 may select any initial pair of bounding boxes (e.g., one from each of image_1 and image_2) and work through all permutations of images boxes.

For the bounding box pair (bbox1 and bbox2), overlap ratio calculator 420 may calculate the intersection area (IArea) between the two bounding boxes, as indicated by 520 of process 500. The intersection area may be an area within each bounding box where the pixel distribution is identical between bbox1 and bbox2. For example, overlap ratio calculator 420 may compute an overlapping rectangle (if any) between bbox1 and bbox2.

For the same bounding box pair (bbox1 and bbox2), overlap ratio calculator 420 may also calculate the union area between the two bounding boxes, as indicated by 530. The union area (UArea) may be defined as the area of bbox1 plus the area of bbox2 minus the intersection area.

Overlap ratio calculator 420 may then compute the overlap ratio (OR) for the bounding box pair, as shown at 540, where the overlap ratio equals the intersection area divided by the union area (OR=IArea/UArea). Overlap ratio calculator 420 may compare the resulting overlap ratio to a merge threshold, which may be tuned for a particular use case, application, or environment. For example, the merge threshold may be 0.5, 0.6, 0.8, etc. If the overlap ratio is above the merge threshold, overlap ratio calculator 420 may mark the bound box pair (bbox1 and bbox2) for merging. In one implementation, overlap ratio calculator 420 may perform steps 520-540 to compare all bounding box permutations between image_1 and image_2, upon which overlap ratio calculator 420 may forward the corresponding RGB array representations of image_1 and image_2, as marked, to merged image generator 430.

Comparing all permutations of bounding boxes from two images can be computationally expensive, especially if there are many objects. To optimize the process, different logic options may be used to prioritize or reduce the number comparisons. For example, overlap ratio calculator 420 may compare only objects with the same class label (e.g., car, tree, building). As another example, overlap ratio calculator 420 may use spatial proximity filtering, where bounding boxes are compared only if they are spatially close to each other. Additionally, overlap ratio calculator 420 may sort bounding boxes by size or area, such that objects with similar dimensions (width and height) are prioritized for comparison. As still another example, overlap ratio calculator 420 may use early termination of a comparison test whenever initial testing fails to reach a minimum overlap threshold. Thus, overlap ratio calculator 420 would only proceed with detailed computations for bounding box pairs with potential overlaps.

Returning to FIG. 4, merged image generator 430 may receive the marked RGB array representations of image_1 and image_2 from overlap ratio calculator 420. Merged image generator 430 may append together the arrays to obtain an RGB array representation of the merged arrays. The merged arrays may be used to generate a merged image.

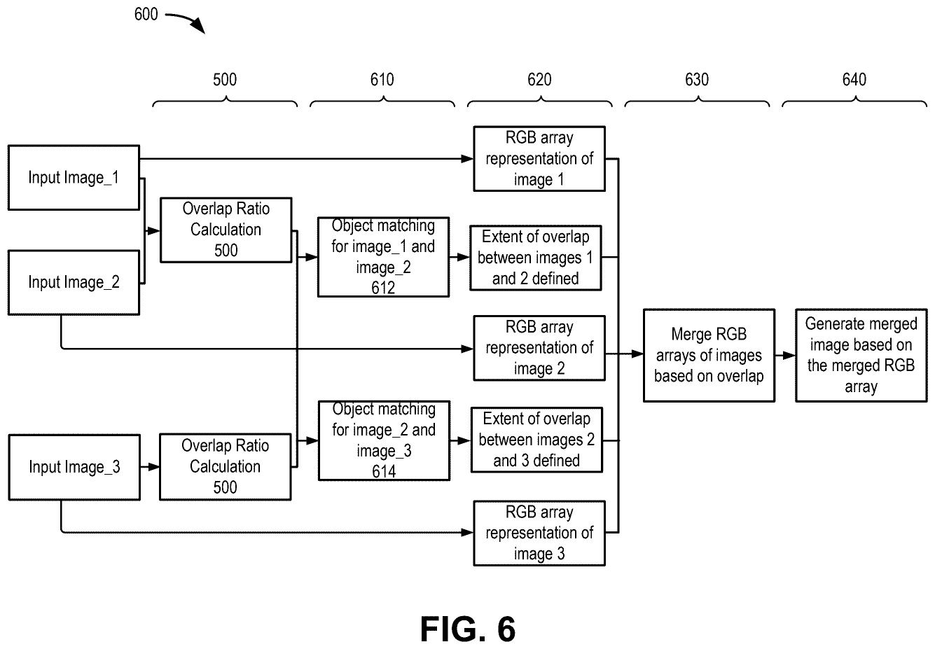

FIG. 6 is an example of a process 600 for merged image generator 430 according to an implementation. Process flow 500, described above, is shown in the context of process 600. As shown in FIG. 6, merged image generator 430 may, at block 610, receive marked RGB array representations from overlap ratio calculator 420. When more than two images are available to me merged, marked RGB arrays may be provided for pairs of images, such as image_1 and image_2, as shown at block 612, and image_2 and image_3, as shown at block 614. The marked RGB arrays may indicate matching objects that have an overlap ratio above the merging threshold.

In process block 620, for each pair of objects where overlap ratio above the merging threshold (e.g., an object_1 from image_1 and an object_2 from image_2), merged image generator 430 may identify the overlapping region between the images (e.g., the intersection of the bounding boxes of object_1 and object_2). In one implementation, merged image generator 430 may match objects from one edge (e.g., the right side) of image_1 to objects from an opposite edge (e.g., the left side) of image_2. Thus, at process block 620, merged image generator 430 may have an original RGB array representation of image_1, an original RGB array representation of image_2, and the defined overlap region between image_1 and image_2. Similarly, when a third image (e.g., image_3) is being considered, merged image generator 430 may match objects from one edge (e.g., the right side) of image_2 to objects from an opposite edge (e.g., the left side) of image_3. Thus, at process block 620, merged image generator 430 may also have an original RGB array representation of image_3 and the defined overlap region between image_2 and image_3.

At process block 630, merged image generator 430 may merge the RGB arrays of images 1, 2, and 3 based on the overlap between the images. More particularly, merged image generator 430 may merge overlapping pixels from the images to form a merged RBG array. For example, for each pixel in an overlapping region, merged image generator 430 may use/keep the pixel from the first/earlier image in sequence. Thus, to eliminate overlapping pixels, merged image generator 430 may use an overlapping pixel from image_1 if it lies within the overlap area and otherwise use a pixel from image_2. In other implementations, a different merging approach may be used, such as blending pixel values using a blending method for pixels in an overlapping region.

At process block 640, merged image generator 430 may generate the merged image based on the merged RGB array. For example, merged image generator 430 may update the merged image with the newly merged region. Thus, merged image generator 430 may merge multiple images into a single image that may exceed the field-of-view otherwise available from a single image.

In some implementations, the merged images may be applied to inventory control, monitoring, or other systems. For example, merged images may be provided to object detection systems that store, for example, a catalog of inventory objects, equipment, structures, etc. Objects in the merged image may be compared to the objects present in a catalog image to detect changes and/or anomalies.

The logical components shown in FIG. 4 are examples. According to other embodiments, image processing system 210 may include additional logical components, fewer logical components, and/or different logical components, than those illustrated in FIG. 4 to accomplish similar objectives. For example, one or more of initial image processor 410, overlap ratio calculator 420, or merged image generator 430 may be combined with other systems within or outside of network environment 200 as part of one or more devices.

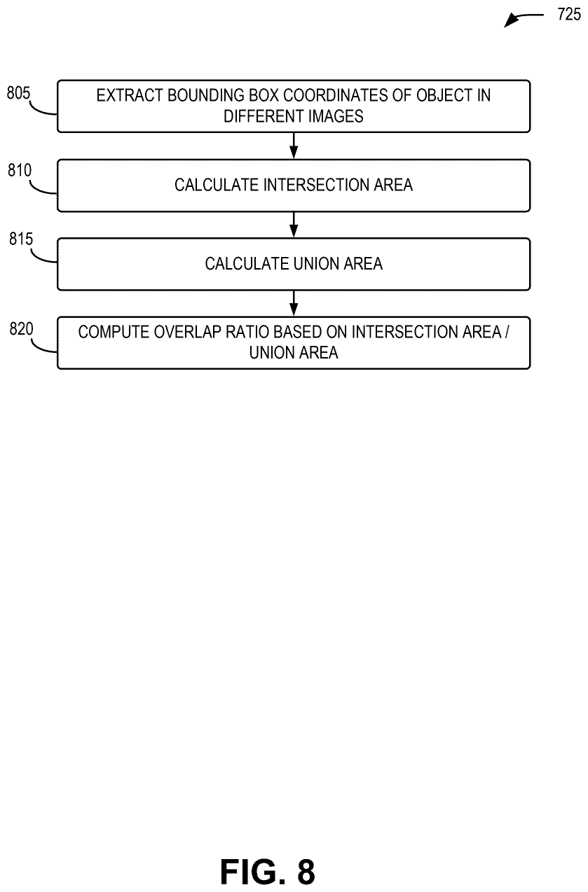

FIGS. 7 and 8 are flow diagrams illustrating a process 700 for performing image merging. In one implementation, process 700 may be implemented by image processing system 210. In another implementation, process 800 may be implemented by image processing system 210 in conjunction with one or more other devices in environment 200, such as computer vision system 220 and/or camera 230.

As shown in FIG. 7, process 700 may include receiving images (block 705), converting the images into pixel array representations (block 710), and detecting objects in a current image and a next image (blocks 715A/715B). For example, initial image processor 410 of image processing system 210 may receive a set of images from camera 230. Initial image processor 410 may convert and/or analyze an RGB array of each image in the set of images. Using the RGB array, for example, initial image processor 410 may perform initial object detection and other processing of each received image. For example, initial image processor 410 may detect one or more of the same objects (e.g., products, equipment, etc.) in multiple images.

Process 700 may also include generating bounding boxes for the detected objects (block 720) and computing an overlap ratio for the overlap between bounding boxes of the same object (block 725). For example, initial image processor 410 may identify bounding boxes for each object detected in the set of images and identify common (e.g., potentially the same) objects in different images. The same object in different images may be associated as a bounding box pair. Overlap ratio calculator 420 of image processing system 210 may compute the overlap ratio for a bounding box pair of the same object in different images. For example, overlap ratio calculator 420 may calculate the overlap ratio using the steps described further in connection with FIG. 8.

Process 700 may further include determining if the overlap ratio exceeds a threshold (block 730). For example, overlap ratio calculator 420 may compare the calculated overlap ratio to a stored merge threshold. In one implementation, the merge threshold may be defined/tuned for a selected use case, application, or environment.

If the overlap ratio exceeds a threshold (block 730 - Yes), process 700 may additionally include identifying an overlapping region between the bounding boxes of the same object (block 735), appending pixels within the overlapping region to form a merged area (block 740), and appending array representations of the images to include the merged area (block 745). For example, when an overlap ratio is above the merging threshold, merged image generator 430 may identify the overlapping region between the different bounding boxes in the images. Merged image generator 430 may merge overlapping pixels from the images to define a merged area and use the merged area to form a merged RBG array. For example, for each pixel in an overlapping region, merged image generator 430 may use/retain the pixel from the first/earlier image in sequence and discard overlapping pixel from the second/subsequent image. Merged image generator 430 may then form a merged pixel array from the union of the non-overlapping area of the first image, the non-overlapping area of the second image, and the merged area. In some implementations, merged image generator 430 may convert the merged pixel array into a merged image.

According to an implementation, process block 725 may include the steps shown in FIG. 8. As shown in FIG. 8, process block 725 may include extracting bounding box coordinates of an object in different images (block 805), calculating an intersection area (block 810), calculating a union area (block 815), and computing an overlap ratio based on the intersection area and the union area (block 820). For example, overlap ratio calculator 420 of image processing system 210 may extract bounding box coordinates (e.g., minimum and maximum bounding box coordinates) from the corresponding RGB array representations of each image. For the bounding box pair, overlap ratio calculator 420 may calculate the intersection area (IArea) between the two bounding boxes. The intersection area may be an area within each bounding box where the pixel distribution is identical between the two bounding boxes. For the same two bounding boxes, overlap ratio calculator 420 may also calculate the union area. The union area (UArea) may be defined as the area of bbox1 plus the area of bbox2 minus the intersection area. Overlap ratio calculator 420 may then compute the overlap ratio (OR) for the bounding box pair, where OR=IArea/UArea.

Systems and methods described herein provide for an efficient and accurate image merging system. A computing device receives multiple images including a first image and a second image. The computing device detects objects in pixel array representations of each of the multiple images and generates a bounding box for each of the objects. The computing device computes an overlap ratio for a first bounding box in the first image and a second bounding box in the second image and identifies the first bounding box and the second bounding box as an overlapping region when the overlap ratio exceeds a defined merge threshold. The computing device appends pixels within the overlapping region to form a merged area and creates a merged pixel array representation of the first image and the second image from a pixel array representation of the first image, a pixel array representation of the second image, and a pixel array representation of the merged area.

In contrast with implementations described herein, conventional image merging systems are not highly reliable when merging multiple images together, especially if the end objective is to detect and identify objects in the merged image. The implementations described herein first identify objects in the individual images, and then based on the objects identified, estimate the amount of overlap between images to be merged. Subsequently, the array representations of the images are appended to generate the array representation of a merged image. Thus, systems and methods described herein provide a more efficient process to detect objects in the merged image, rather than first merging the images together and then trying to identify objects.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described with regard to the processes illustrated in FIGS. 5-8, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 320, etc.), or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 320) of a device. A non-transitory storage medium includes one or more of the storage mediums described in relation to memory 330.

To the extent the aforementioned embodiments collect, store or employ personal information of individuals, it should be understood that such information shall be collected, stored and used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such. All structural and functional equivalents to the elements of the various aspects set forth in this disclosure that are known or later come to be known are expressly incorporated herein by reference and are intended to be encompassed by the claims.

What is claimed is:

1. A method, comprising:
receiving, by a computing device, multiple images including a first image and a second image;
detecting, by the computing device, objects in pixel array representations of each of the multiple images;
generating, by the computing device, a bounding box for each of the objects;
computing, by the computing device, an overlap ratio for a first bounding box in the first image and a second bounding box in the second image;
identifying, by the computing device, the first bounding box and the second bounding box as an overlapping region when the overlap ratio exceeds a defined merge threshold;
appending, by the computing device, pixels within the overlapping region to form a merged area; and
creating, by the computing device, a merged pixel array representation of the first image and the second image from a pixel array representation of the first image, a pixel array representation of the second image, and a pixel array representation of the merged area.

2. The method of claim 1, wherein the first bounding box and the second bounding box are associated with a same object.

3. The method of claim 1, wherein computing the overlap ratio includes:
calculating an intersection area of the first bounding box and the second bounding box,
calculating a union area of the first bounding box and the second bounding box, and
calculating the overlap ratio from the intersection area and the union area.

4. The method of claim 3, wherein computing the overlap ratio further includes:
extracting bounding box coordinates of the first bounding box and the second bounding box.

5. The method of claim 1, wherein the defined merge threshold is defined for a selected use case.

6. The method of claim 1, wherein the appending includes:
retaining pixels from the first image and discarding overlapping pixels, in the second image, within the merged area.

7. The method of claim 1, wherein the pixel array representation of the merged area includes a red, green, blue (RGB) array representation.

8. The method of claim 1, further comprising:
generating, by the computing device, a merged image based on the pixel array representation of the merged area.

9. The method of claim 1, further comprising:
storing, by the computing device, each of the multiple images as a pixel array representation.

10. A computing device comprising:
a processor configured to:
receive multiple images including a first image and a second image;
detect objects in pixel array representations of each of the multiple images;
generate a bounding box for each of the objects;
compute an overlap ratio for a first bounding box in the first image and a second bounding box in the second image;
identify the first bounding box and the second bounding box as an overlapping region when the overlap ratio exceeds a defined merge threshold;
append pixels within the overlapping region to form a merged area; and
create a merged pixel array representation of the first image and the second image from a pixel array representation of the first image, a pixel array representation of the second image, and a pixel array representation of the merged area.

11. The computing device of claim 10, wherein, when computing the overlap ratio, the processor is further configured to:
compute the overlap ratio for the first bounding box and the second bounding box associated with a same object.

12. The computing device of claim 10, wherein, when computing the overlap ratio, the processor is further configured to:
calculate an intersection area of the first bounding box and the second bounding box,
calculate a union area of the first bounding box and the second bounding box, and
calculate the overlap ratio from the intersection area and the union area.

13. The computing device of claim 10, wherein, when appending the pixels within the overlapping region, the processor is further configured to:
retain pixels from the first image and discard overlapping pixels, in the second image, within the merged area.

14. The computing device of claim 10, wherein, when creating the pixel array representation of the merged area, the processor is further configured to:
create a merged red, green, blue (RGB) array representation.

15. The computing device of claim 10, wherein the processor is further configured to:
generate a merged image based on the pixel array representation of the merged area.

16. The computing device of claim 10, wherein the processor is further configured to:
store each of the multiple images as a pixel array representation.

17. A non-transitory computer-readable storage medium storing instructions, which are executable by one or more processors, for:
receiving multiple images including a first image and a second image;
detecting objects in pixel array representations of each of the multiple images;
generating a bounding box for each of the objects;
computing an overlap ratio for a first bounding box in the first image and a second bounding box in the second image;
identifying the first bounding box and the second bounding box as an overlapping region when the overlap ratio exceeds a defined merge threshold;
appending pixels within the overlapping region to form a merged area; and
creating a merged pixel array representation of the first image and the second image from a pixel array representation of the first image, a pixel array representation of the second image, and a pixel array representation of the merged area.

18. The non-transitory computer-readable storage medium of claim 17, wherein the first bounding box and the second bounding box are associated with a same object.

19. The non-transitory computer-readable storage medium of claim 17, wherein the instructions for computing the overlap ratio further comprise instructions for:
calculating an intersection area of the first bounding box and the second bounding box,
calculating a union area of the first bounding box and the second bounding box, and
calculating the overlap ratio from the intersection area and the union area.

20. The non-transitory computer-readable storage medium of claim 17, further comprising instructions for:
generating a merged image based on the pixel array representation of the merged area.
